(19) United States
(12) Patent Application Publication
(10) Pub. No.: US 2005/0075143 A1
(43) Pub. Date: Apr. 7, 2005

(54) Mobile communication terminal having voice recognition function, and phoneme modeling method and voice recognition method for the same

(75) Inventor: Goan-Mook Choi, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Ichon-Si (KR)

(21) Appl. No.: 10/781,714

(22) Filed: Feb. 20, 2004

(30) Foreign Application Priority Data
Oct. 6, 2003 (KR) 10-2003-0069219

(51) Int. Cl. H04M 1/00

(52) U.S. Cl. 455/564

(57) ABSTRACT

Disclosed is a mobile communication terminal using a phoneme modeling method for voice recognition. The terminal includes a voice input unit, a storage unit and controller. The voice input unit is used to input a speech sound. The storage unit stores reference phoneme models of respective feature vectors of phonemes, produced by a speech sound inputted by the user. The controller segments the input speech sound into phonemes, extracts respective feature vectors from the phonemes, and performs pattern matching between the extracted feature vectors and the reference phoneme models, so as to recognize the input speech sound.

### BACKGROUND OF THE INVENTION

1. Field of the Invention

The present invention relates to voice recognition for mobile communication terminals, and more particularly to a phoneme modeling method for voice recognition, a voice recognition method based thereon, and a mobile communication terminal using the same.

2. Description of the Related Art

A voice recognition system recognizes user's speech sounds and performs a corresponding operation to the speech sound. The voice recognition system extracts features of the input speech sound, and performs pattern matching between the extracted features and reference speech models, thereby recognizing the input speech sound. As the number of times operation (i.e., training) for the reference speech models is performed increases, more general reference speech models can be obtained.

One example of the voice recognition system is a speaker-dependent voice recognition system. Since each mobile communication terminal has a single user, it is suitable to use user's speech sounds to make a database for voice recognition. For this reason, mobile communication terminals mostly employ the speaker-dependent voice recognition system. For example, the speaker-dependent voice recognition system for mobile communication terminals creates a reference speech model for a desired word such as “my place” by repeatedly inputting a speech sound corresponding to the word. Thus, it is inconvenient in that the user has to repeatedly input a speech sound corresponding to each of the words, such as my place, office, husband's house, etc., which are required for voice dialing or control of the terminal, in order to create the reference speech models.

The conventional voice recognition system for mobile communication terminals is designed, for its properties, to improve the voice recognition rate through repeated training. However, the voice recognition system employed in mobile communication terminals has limitations to improving the voice recognition rate since it uses an already implemented database of reference speech models, or since it is programmed such that the number of inputting times a speech sound to be trained is limited to, for example, twice or three times for each word.

### SUMMARY OF THE INVENTION

It is an object of the present invention to provide a phoneme modeling method and a voice recognition method in which a voice recognition rate is high.

It is another object of the present invention to provide a mobile communication terminal with a voice recognition function in which a voice recognition rate is high.

In accordance with one aspect of the present invention, the above and other objects can be accomplished by the provision of a mobile communication terminal comprising: a display unit for displaying a character; a voice input unit through which a speech sound is inputted; a storage unit for storing reference phoneme models of respective feature vectors of phonemes of the input speech sound; and a controller for segmenting the speech sound inputted for the displayed character into the phonemes, extracting respective feature vectors from the phonemes, and generating and storing the reference phoneme models based on the extracted feature vectors respectively.

In accordance with another aspect of the present invention, there is provided a phoneme modeling method comprising the steps of: receiving an input speech sound corresponding to a displayed character; segmenting the input speech sound into phonemes; extracting respective feature vectors from the phonemes; and generating and storing reference phoneme models based on the feature vectors respectively.

In accordance with a further aspect of the present invention, there is provided a voice recognition method comprising the steps of: a) receiving an input speech sound corresponding to a displayed character; b) generating and storing reference phoneme models of feature vectors corresponding respectively to phonemes of the speech sound; c) receiving an input speech sound; d) segmenting the input speech sound into phonemes, and extracting respective feature vectors from the phonemes; and e) recognizing the speech sound by performing pattern matching between the extracted feature vectors and said stored reference phoneme models of the feature vectors.

According to the present invention, reference phoneme models respectively for consonants and vowels of a predetermined language (for example, the Korean language) can be produced in advance in the manner described above. Thus, it is possible to continually update reference phoneme models respectively for phonemes only by inputting a speech sound corresponding to a displayed character, thereby improving the voice recognition rate.

In addition, since voice recognition is possible for all the predetermined language's words, it is possible for the user to avoid the inconvenience of having to repeatedly input speech sounds required for the voice recognition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a mobile communication terminal according to an embodiment of the present invention;

FIG. 2 is a flowchart illustrating the procedure for performing phoneme modeling according to the embodiment of the present invention; and

FIG. 3 is a flowchart illustrating the procedure for performing voice recognition based on the phoneme modeling according to the embodiment of the present invention.

### DESCRIPTION OF THE PREFERRED EMBODIMENTS

Now, preferred embodiments of the present invention will be described in detail with reference to the annexed drawings. In the following description, a detailed description of known functions and configurations incorporated herein will be omitted when it may make the subject matter of the present invention rather unclear.

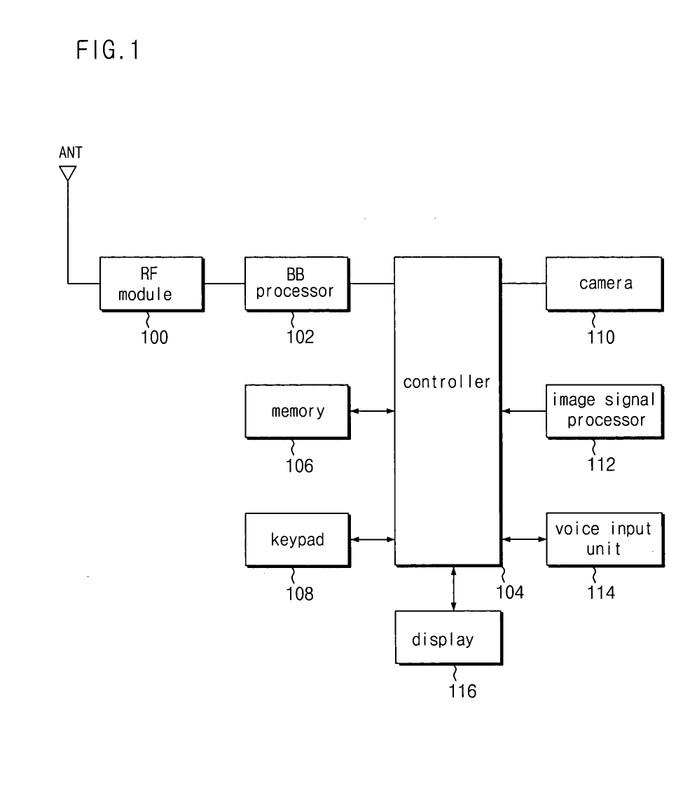

FIG. 1 is a block diagram showing a mobile communication terminal, particularly a camera phone, according to an embodiment of the present invention.

As shown in this figure, the mobile communication terminal includes an RF (Radio Frequency) module 100, a baseband processor 102, a controller 104, a memory 106, a keypad 108, a camera 110, an image signal processor 112, a voice input unit 114, a display unit 116, and an antenna ANT.

The RF module 100 demodulates an RF signal received from a base station through the antenna ANT, and transfers the demodulated signal to the baseband processor 102. On the other hand, the RF module 100 modulates a signal provided from the baseband processor 102 into an RF signal, and transmits the RF signal to the base station through the ANT.

The baseband processor 102 converts an analog signal outputted from the RF module 100 into a digital signal after performing down-conversion on the analog signal, and provides the converted signal to the controller 104. On the other hand, the baseband processor 102 converts a digital signal provided from the controller 104 into an analog signal, and then transfers the converted signal to the RF module 100 after performing up-conversion on the analog signal.

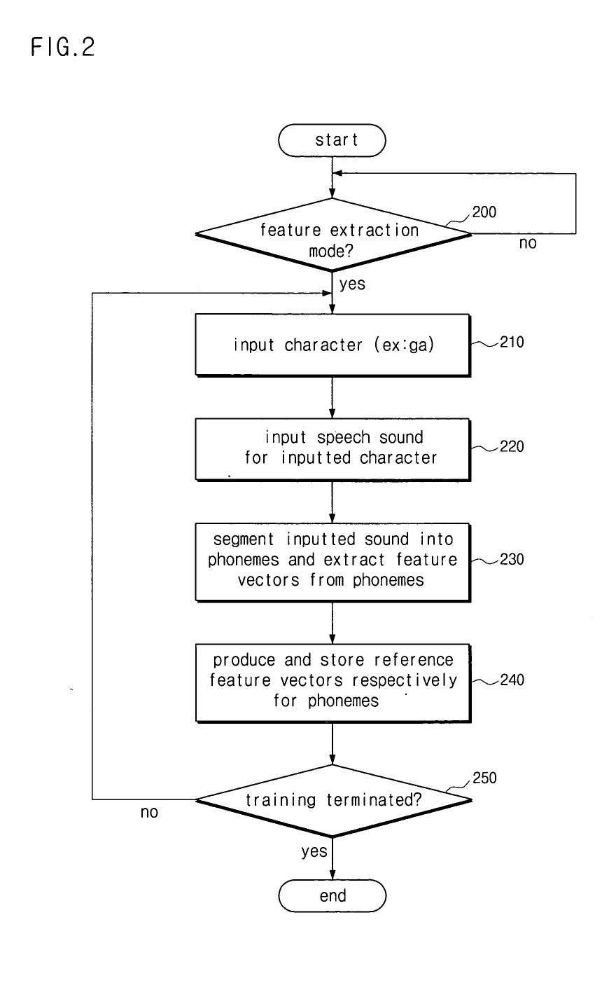

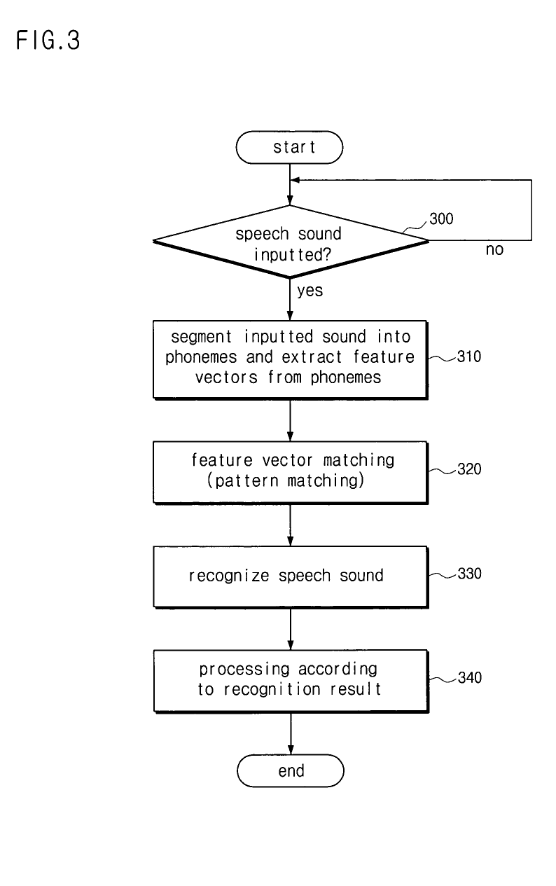

The controller 104 controls the overall operation of the mobile communication terminal (also referred to as a “camera phone”) based on control program data stored in the memory 106, described below. For example, the controller 104 operates in the following manner according to procedures as shown in FIGS. 2 and 3. The controller 104 generates and stores reference phoneme models for respective phonemes. In addition, the controller 104 extracts features from respective phonemes that constitute a speech sound inputted by a user, and then performs pattern matching between the extracted features and the reference phoneme models, thereby recognizing the input speech sound.

The memory 106 stores at least control program data for controlling the operation of the camera phone, image data captured by the camera 110, described below, and reference feature vectors (also referred to as “reference phoneme models”), corresponding to respective phonemes, according to the embodiment of the present invention.

The keypad 108 is a user interface for inputting characters, which includes 4×3 character keys and a number of function keys as known in the art. This keypad 108 may also be called a “character input unit”.

The camera 110 captures an image of object and outputs the captured image signal. The image signal processor 112 performs signal processing on the captured image signal outputted from the camera 110, and generates and outputs a single-frame image.

The voice input unit 114 amplifies a voice signal inputted through the microphone, and converts the amplified signal into digital data. Then, the voice input unit 114 processes the converted data into a signal required for voice recognition, and outputs the processed signal to the controller 104.

The display unit 116 displays text or the captured image data under the control of the controller 104.

A voice recognition method of the present invention will be explained below in detail. The voice recognition method basically includes the following two processes: a phoneme modeling process and a voice recognition process. For the phoneme modeling process, a speech sound for a character, pronounced by the phone' user, is segmented into phonemes and the respective reference phoneme models for the segmented phonemes are produced to make a database thereof. For the voice recognition process, while an input speech sound is segmented into phonemes, respective feature vectors for the phonemes are extracted, and pattern matching is performed between the extracted feature vectors and the reference phoneme models in the database.

The phoneme modeling process for producing reference phoneme models for respective phonemes to make the database thereof is illustrated in FIG. 2, and the voice recognition process for recognizing an input speech sound is illustrated in FIG. 3. The term “phoneme” in this application is referred to the smallest phonetic unit in a language like consonants and vowels.

Referring first to FIG. 2, reference phoneme models for the phonemes are produced. When the user selects and activates a phoneme modeling mode, the controller 104 detects the phoneme modeling mode at step 200, and requests the user to input (or select) a character at step 210. This character may be a character inputted by the user through the keypad 108, and as circumstances demand, may also be a character included in a document transmitted by a server connected to the wireless Internet or a character included in an SMS message received through an RF module. Here, it should be noted that reference phoneme models for respective phonemes, which constitute a speech sound corresponding to the inputted or selected character, are produced by allowing the user to input the speech sound corresponding to the inputted or selected character after the character is displayed on the display unit 116.

When the user inputs a character (for example, a Korean character [symbol] pronounced as “ga” in English) at step 210, the controller 104 requests a user to input a speech sound corresponding to the inputted character. When the user pronounces the character inputted, the corresponding speech sound is inputted through the voice input unit 114 at step 220.

When the speech sound corresponding to the input character has been inputted through the voice input unit 114, the controller 104 segments the input speech sound into phonemes (for example, Korean phonemes [symbol] and [symbol] corresponding respectively to English phonemes “g” and “a”), and extracts respective feature vectors from the segmented phonemes at step 230. The controller 104 then advances to step 240 to store the extracted feature vectors while setting the extracted feature vectors as reference feature vectors. The reason why the feature vectors extracted from the segmented phonemes are set as the reference feature vectors at step 230 is because it is assumed that this character input has been performed for the first time.

Thereafter, when the user inputs a new character [symbol] pronounced as “na” in English at step 210 and then inputs a speech sound corresponding to [symbol] at step 220, the controller 104 performs the process of step 230, with the result that feature vector extraction is performed two times for the Korean phoneme [symbol] (corresponding to the English phoneme “a”). Accordingly, the average of the two feature vectors extracted from the phoneme [symbol] may be calculated and set as the corresponding reference feature vector. Consequently, the respective reference phoneme models are obtained for the Korean phonemes [symbol] [symbol] and [symbol] in this example.

In other words, according to the present invention, the reference phoneme models are produced in the following manner. When the user inputs speech sounds corresponding respectively to characters inputted or selected by him or her, respective feature vectors of phonemes constituting the speech sounds are extracted from the phonemes. New reference feature vectors for the respective phonemes are produced by calculation based on both the currently extracted feature vectors and reference feature vectors previously stored for the same phonemes. In this manner, the repeated training permits the reference phoneme models in the database to be repeatedly updated, thereby producing the respective reference phoneme models for all the consonants and vowels.

Now, the process for performing voice recognition based on the reference phoneme models produced in the method described above is described with reference to FIG. 3.

At step 300, the controller 104 checks whether a speech sound is inputted through the voice input unit 114. If a speech sound “my place” has been inputted as voice information to call the user's place, the controller 104 segments the inputted speech sound into phonemes and extracts respective feature vectors from the segmented phonemes at step 310. Next, at step 320, the controller 104 performs pattern matching between the extracted feature vectors and reference phoneme models stored in the memory 106. An HMM (Hidden Markov Model) algorithm may be used to perform this pattern matching.

At step 330, the controller 104 performs voice recognition by extracting and combining phonemes corresponding to the reference phoneme models to be matched to the extracted feature vectors. Next, processing corresponding to the recognition result is performed at step 340. For example, automatic dialing is performed according to the recognition result. Of course, in order to perform the automatic dialing, it is necessary to have previously registered a phone number of the user's place as “my place: 02-888-8888”.

According to the present invention, the user has already produced respective reference phoneme models for the phonemes of a predetermined language (for example, the Korean language), so as to recognize speech sounds of all the predetermined language's words, as described above in the embodiment. This permits the user to call his or her place by inputting a speech sound of “my place” as illustrated above, without having previously inputted repeatedly the speech sound of “my place”.

As apparent from the above description, the present invention has an advantage in that it can improve the voice recognition rate, since a user is allowed to input a speech sound corresponding to a displayed character, so as to continually update the reference phoneme models respectively for phonemes constituting the inputted speech sound. The present invention is also advantageous in that it is possible to recognize a speech sound corresponding to a word, without performing repeated training of the speech sound. This means that it is possible to recognize speech sounds of all the words of a predetermined language (for example, the Korean language).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile communication terminal comprising:
a display unit for displaying a character;
a voice input unit through which a speech sound is inputted;
a storage unit for storing reference phoneme models of respective feature vectors of phonemes of the input speech sound; and
a controller for segmenting the speech sound inputted for the displayed character into the phonemes, extracting respective feature vectors from the phonemes, and generating and storing the reference phoneme models based on the extracted feature vectors respectively.

2. The mobile communication terminal according to claim 1, further comprising a keypad for inputting a character to be displayed on the display unit.

3. The mobile communication terminal according to claim 2, further comprising an RF module for wirelessly receiving an SMS message containing a character to be displayed on the display unit.

4. The mobile communication terminal according to claim 3, wherein the controller segments an input speech sound into phonemes, extracts respective feature vectors from the phonemes, and performs pattern matching between the extracted feature vectors and stored reference phoneme models of respective feature vectors of phonemes, thereby recognizing the input speech sound.

5. A phoneme modeling method comprising the steps of:
receiving an input speech sound corresponding to a displayed character;
segmenting the input speech sound into phonemes;
extracting respective feature vectors from the phonemes; and
generating and storing reference phoneme models based on the feature vectors respectively.

6. The method according to claim 5, further comprising the step of:
receiving an input character and displaying the character on a display unit.

7. The method according to claim 5, further comprising the step of:
wirelessly receiving information of a character and displaying the character on a display unit.

8. The method according to claim 7, wherein the information of the character includes an SMS message.

9. A voice recognition method comprising the steps of:
a) receiving an input speech sound corresponding to a displayed character;
b) generating and storing reference phoneme models of feature vectors corresponding respectively to phonemes of the speech sound;
c) receiving an input speech sound;
d) segmenting the input speech sound into phonemes, and extracting respective feature vectors from the phonemes; and
e) recognizing the speech sound by performing pattern matching between the extracted feature vectors and said stored reference phoneme models of the feature vectors.

10. The method according to claim 9, wherein said step b) includes the steps of:
segmenting an input speech sound into phonemes;
extracting respective feature vectors from the segmented phonemes; and
generating and storing reference phoneme models respectively for the phonemes based on the extracted feature vectors.

11. The method according to claim 10, further includes the step of:
receiving an input character and displaying the input character on a display unit.

12. The method according to claim 10, further includes the step of:
wirelessly receiving information of a character and displaying the character on a display unit.

13. The method according to claim 12, wherein the information of the character includes an SMS message.
